(19) United States
(12) Patent Application Publication
(10) Pub. No.: US 2015/0113824 A1
(43) Pub. Date: Apr. 30, 2015

(54) DRYING CABINET FOR CLOTHING AND SPORTS EQUIPMENT

(71) Applicant: Adaptive Storage Systems Inc., Toronto (CA)

(72) Inventor: Richard Goulet, Toronto (CA)

(73) Assignee: Adaptive Storage Systems Inc., Toronto, ON (CA)

(21) Appl. No.: 14/064,051

(22) Filed: Oct. 25, 2013

(51) Int. Cl. F26B 21/00

(52) U.S. Cl. CPC F26B 21/001
USPC 34/443; 34/218

(57) ABSTRACT

The present invention relates to a cabinet for storage and drying of sports equipment and/or clothes. This cabinet has doors, an air circulation fan and an exhaust vent at the bottom, an intake vent at the top, and suspending means for suspending articles such as sports equipment or clothes. Turning on the fan activates active drying of the articles. Additionally, the present invention relates to a method of storing and drying articles comprising suspending the articles in a cabinet with doors, the interior of said cabinet comprising an air circulation fan and an exhaust vent at the bottom; an intake vent at the top; and suspending means for suspending the articles. The articles that are difficult or take more time to dry can be placed closest to the fan.

### FIELD OF THE INVENTION

The present invention relates to a drying apparatus and more specifically to a cabinet for storage and drying of sports equipment and/or clothes.

### BACKGROUND OF THE INVENTION

After use, sports equipment and attire is generally damp from sweat, and exposure to air is desirable in order to dry the equipment However, it can take hours far equipment to dry on its own and equipment wet with sweat may have an unpleasant odour which continues to be evident during the drying process, and this odour generally becomes worse after repeated use of the equipment.

At its simplest, sports equipment is typically dried by removing the equipment from its sports bag and airing it by laying it out on a floor, shelves or drying racks strong enough for the weight of the equipment. Since sports equipment can be of various configurations, some pieces dry better than others and some may not dry before being used again. For example, fingers of sports gloves and the inside of boots and skates are particularly difficult to dry.

An example of a product for storage of sports equipment is the ALLSPORT HOT LOCKER™ which is a metal cabinet with the appearance of a gym or school locker.

There are tree shaped units for sports equipment on which sports equipment is hung to air out. There is a ROCKET SPORT DRYER™ which includes a tree for putting equipment on, a bag to cover the tree and then a high powered fan to blow into the bag. There is a DRYLOCKER™ which is a sports bag with a fan to attempt to circulate some air around the equipment packed into the bag.

THE OCTOPUS™ hanger has various cords with clamps to clamp on the hockey equipment. The HOCKEY HANGOUT™ is a hanging square shaped sheet with rows of pouches for placing the various pieces of equipment into.

Sometimes equipment is stored in the home as far as possible from the main traffic areas of the house, such as in the basement, and sometimes equipment is stored in the garage or shed, and there are even cargo boxes for transporting equipment outside of a vehicle, e.g. the STOWAWAY® cargo box.

None of these examples address the issue of odour of the equipment and most provide only storage and do not provide additional drying assistance.

### SUMMARY OF THE INVENTION

The present invention relates to a cabinet for storage and drying of sports equipment and/or clothes. An embodiment of the present invention is a cabinet having an inner cavity extending from the top of the cabinet to the bottom of the cabinet, said cabinet comprising: at least one door; an air intake vent at the top; an air exhaust vent at the bottom; an air circulation fan at the bottom in the inner cavity, said fan capable of being turned on and off; and one or more suspending means in the inner cavity for suspending one or more articles.

In a specific embodiment, the fan is electric and turned on and off with a switch preferably on the outside of the cabinet or with a timer inside or outside of the cabinet. The suspending means are selected from the group comprising: bars, hooks, clamps and hangers. The articles to be suspended are sports equipment or clothing or sports equipment and clothing. The suspending means closest to the fan are capable of suspending the articles that require the most time to dry when said articles contain moisture.

In an embodiment of the present invention there is a cabinet having an inner cavity extending from the top of the cabinet to the bottom of the cabinet, said cabinet comprising: at least one door; an air intake vent at the top; an air exhaust vent at the bottom; an air circulation fan at the bottom in the inner cavity, said fan capable of being turned on and off; and one or more suspending means in the inner cavity for suspending one or more articles, in which the suspending means comprise at least a first horizontal bar adjacent the bottom with hooks for suspending hockey skates and hockey gloves, and above said first bar, a second horizontal bar moulded for suspending shoulder pads.

In an embodiment of the present invention there is a cabinet with at least one door and with a fan in the bottom of the cabinet, wherein when said fan is on and the doors are closed, air enters through an intake vent located near or at the top of the cabinet and exits out an exhaust vent located near or at the bottom of the cabinet.

A further embodiment of the present invention is a method of drying one or more articles comprising the steps of suspending one or more articles in a cabinet having suspending means for suspending the articles, said cabinet also comprising at least one door, an air circulation fan and an exhaust vent at the bottom, and an intake vent at the top; closing the doors; and turning on the fan.

### BRIEF DESCRIPTION OF THE FIGURES

These and other aspects of the present invention will be apparent from the brief description of the drawings and the following detailed description in which:

FIG. 1 is a perspective view of an embodiment of a cabinet of the present invention with doors open.

FIG. 2 is a perspective partial breakaway view drawing of an embodiment of a cabinet of the present invention with one door closed.

FIG. 3 is a front view of an embodiment of a cabinet of the present invention with open doors.

FIG. 4 is art exploded view of an embodiment of a filter holder of the present invention.

FIG. 5 is a side view of an embodiment of a filter holder of FIG. 4 showing the open and closed positions of a vent, and cut away to show the placement of a filter and a fan.

### DETAILED DESCRIPTION OF THE INVENTION

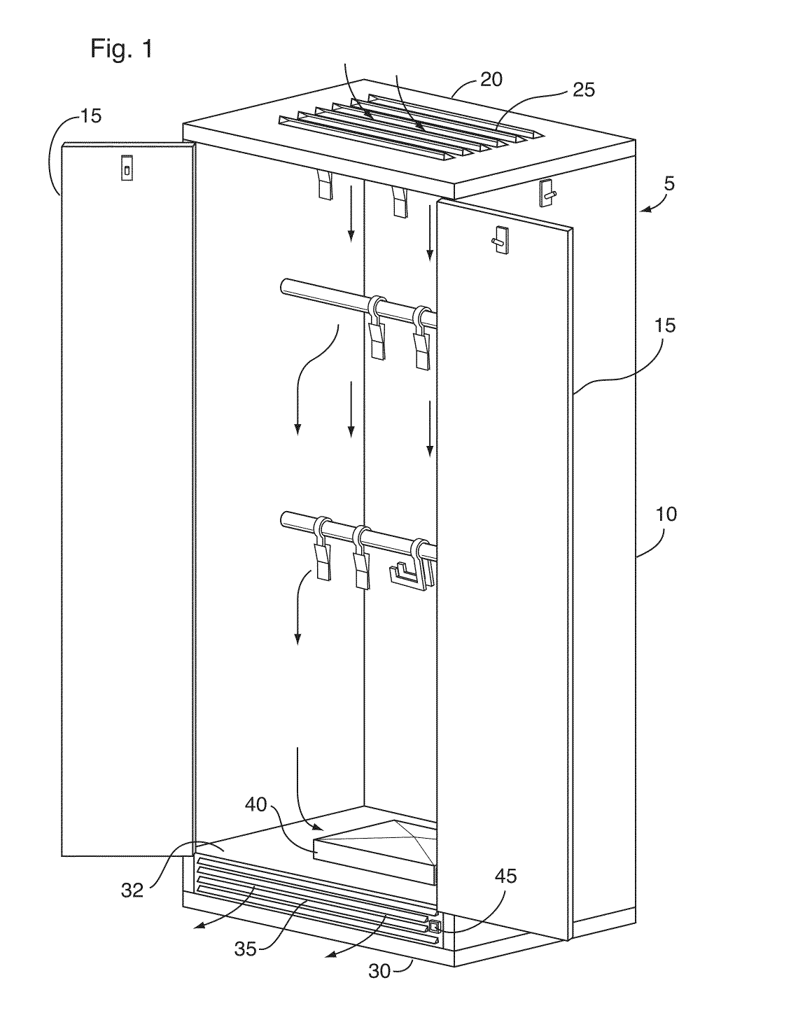

FIG. 1 shows a cabinet 5 of an embodiment of the present invention comprising a body 10 with a top 20, bottom 30 and doors 15. It is understood that there may be one or more doors to access the inner cavity of the cabinet. The top 20 additionally comprises a top vent 25. On a raised floor 32 is a filter holder 40 and underneath the floor 32 is an air circulation fan (not shown) which exhausts through a lower vent 35 and the fan is turned on or off by a switch activated with button 45.

In an embodiment, button 45 can be a toe tap rocker switch for ease of use with a foot tap. The switch for turning the fan on and off can be adapted to alternatively be a timer, for example with 2 and 3 hour time settings, so that the fan is on for a specific amount of time. While the switch is shown near the location of the fan, it is understood that the switch may be located elsewhere on the cabinet and that the fan may be turned on or off by remote control.

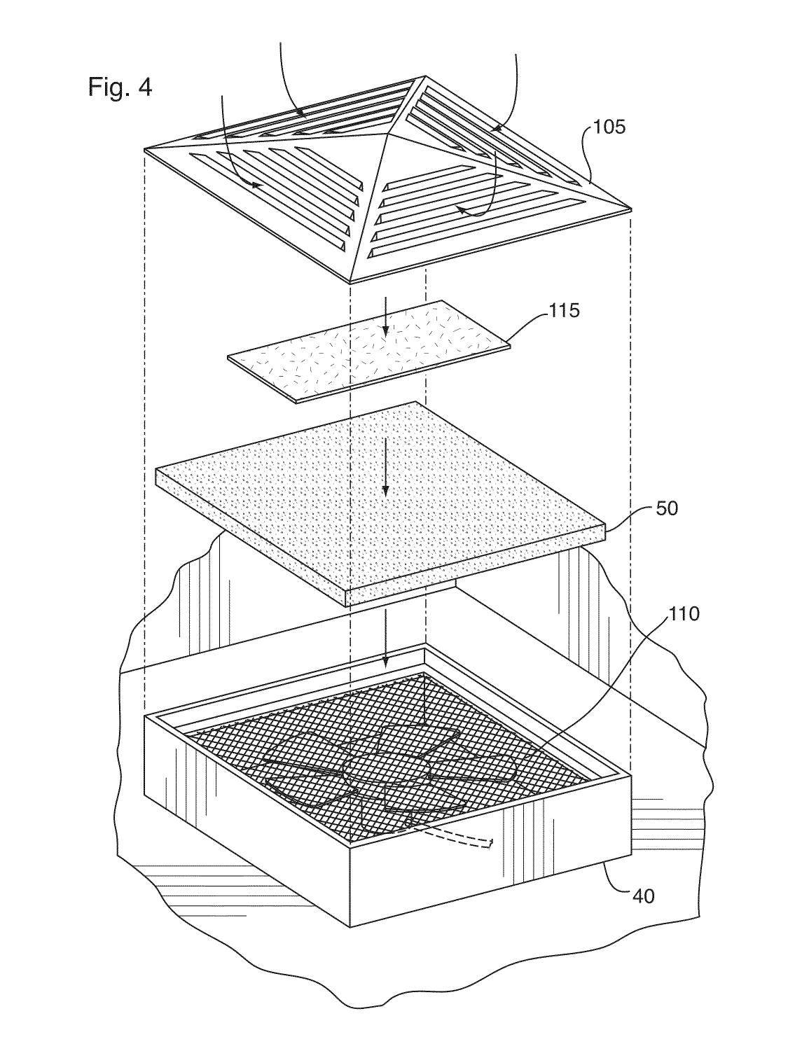

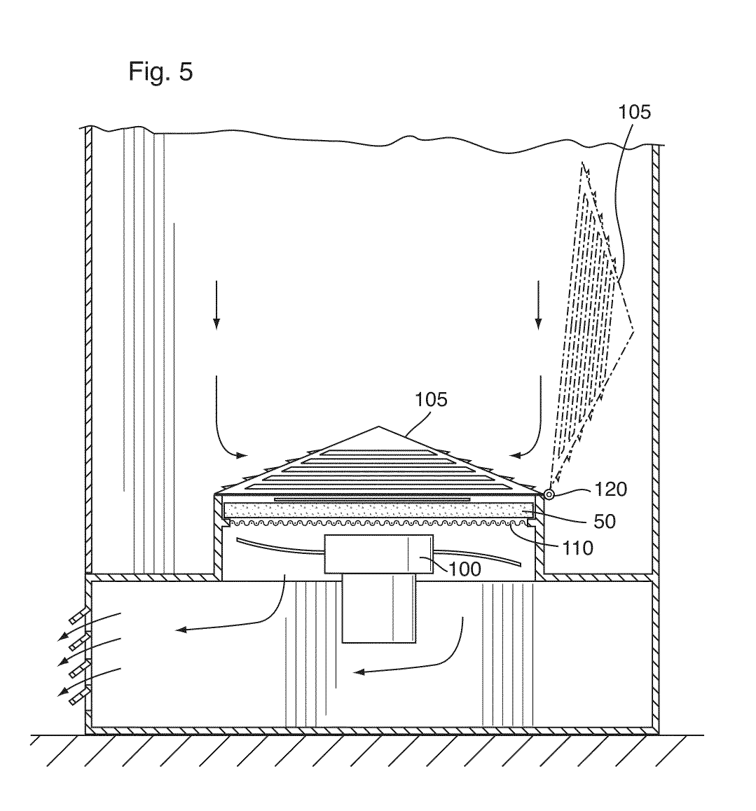

In an embodiment shown in FIGS. 1-3, the filter holder 40 includes a side filter vent 52 for sliding a filter into it as well as venting. Another embodiment of a filter holder with a top vent is shown in FIGS. 4-5.

In an embodiment, the filter holder is shown in the centre of the raised floor 32 and the fan is positioned below it. However, the filter holder may be positioned anywhere at the bottom and this may mean that equipment may be positioned differently to capture the air flow to best advantage. As well the raised floor 32 may be replaced with a raised platform surrounding the fan so that there is more room on either side of the filter holder for further storage. However, the raised floor 32 has aesthetic appeal, provides good air circulation for the fan, and ensures that the equipment is generally positioned above the fan.

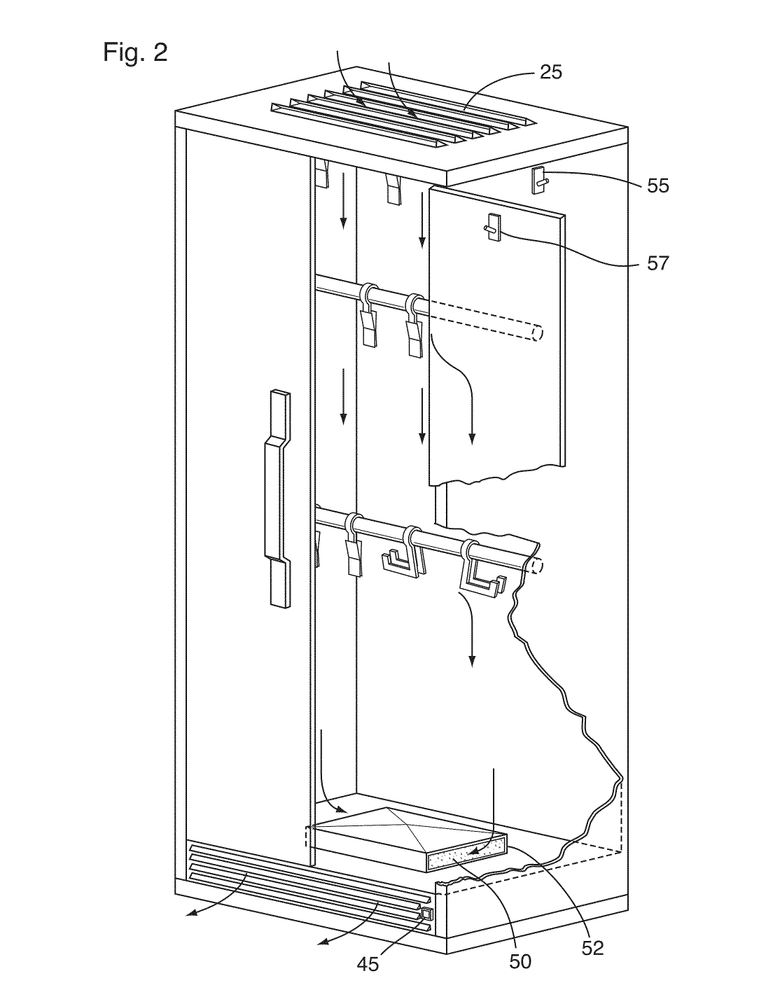

FIG. 2 shows an embodiment of the cabinet 5 in which the filter 50 is seen through a side filter vent 52. The cabinet 5 can include a variety of bars, hooks and clamps for hanging equipment which may be modified to the specific sports equipment to be stored and dried. Equipment can be hung inside the cabinet including on the inside doors such as an inside door hook 57, as well as on the outside on an outside hook 55; however, the equipment on the outside is only hung for storage and possibly general airing, but does not receive the advantage of the interior fan and filter system.

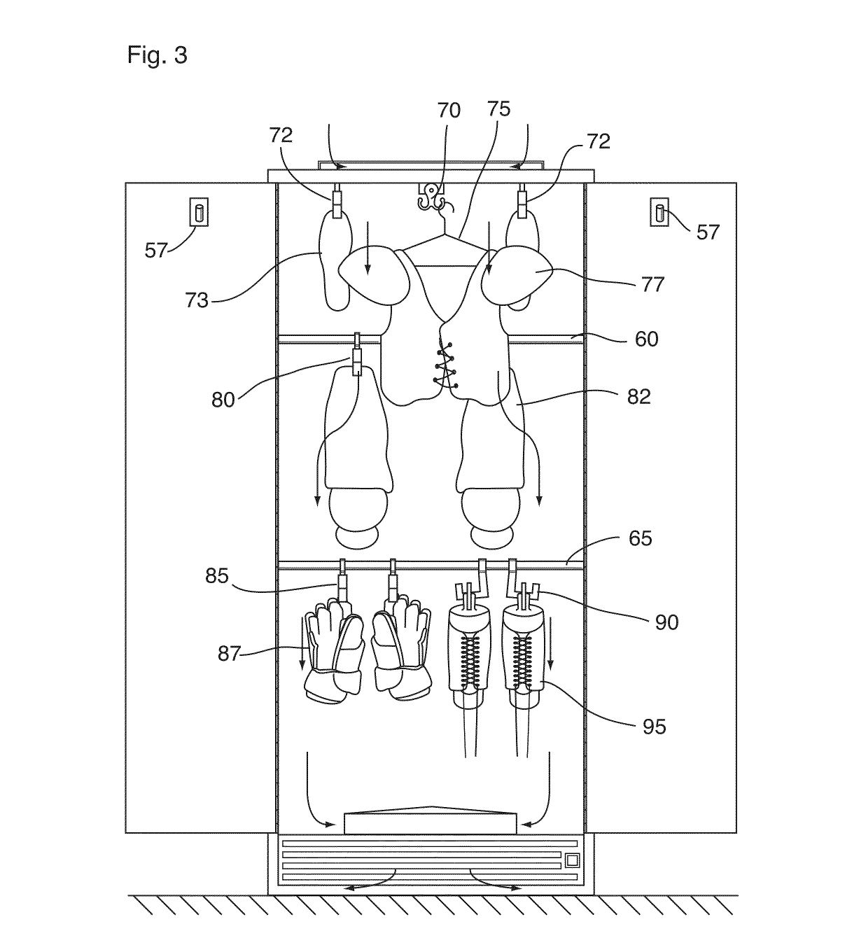

FIG. 3 shows an embodiment of a cabinet of the present invention with horizontal bars, hooks and clamps and hockey equipment. In this embodiment, top hook 70 and top clamps 72 hang from the inside of the top 20 of the cabinet 5, and insoles 73 may be hung on top clamps 72 and a hanger 75 with shoulder pads 77 can be hung on top hook 70.

The hanger 75 can be any hanger including a suit hanger to better hold and spread the shoulders of shoulder pads 77. An upper bar 60 can have mid hooks 80 (one hidden from view) for holding shin pads 82 and additionally have hooks for hockey pants (not shown). A lower bar 65 can have lower clamps 85 for holding gloves 87, and skate blade hooks 90 for holding skates 95. It is understood that any suspending means that will hold sports equipment and/or apparel may be used.

A hanger 75 in a further embodiment is replaced with a modified heavy duty hanger for spreading out the shoulder pads for airing better, or for holding the weight of heavier shoulder pads or a goalie chest protector. The clamps in the embodiment shown in FIGS. 1 to 3 can be replaced with hooks if the equipment is too heavy or slips out of clamps.

In an embodiment, an upper bar 60 can be moved forward towards the doors 15 for better drying of the pants below the shoulder pads or chest protector. Extra hooks on the inside doors are useful for dying under garments and socks.

The positioning of the equipment in FIG. 3 is arranged so that the wettest or hardest to dry equipment is closer to the fan.

FIGS. 1 to 3 show arrows to indicate the direction of air flow when the fan is turned on. Air is pulled into top vent 25, drawn down through the interior of the cabinet, through side filter vent 52 of the filter holder 40 to pass through the filter 50, through the fan and out lower vent 35. Since the fan is at the bottom of the cabinet 5 the most wet and hardest to dry equipment can be placed at the bottom of the cabinet 5.

In another embodiment of the present invention (not shown), an upper bar 60 is moulded in the shape of a large suit hanger to properly rest and position the shoulders pads 77 to ensure open access to air for both the inside and outside panels of the shoulder pads. In this embodiment hockey pants are hung at the top from three hooks namely hook 70 attached at the rear and top of the cabinet and two others (not shown) on either side of hook 70, to support and store the pants in an open position and directly in the downward draft of the air flow. Insoles and elbow pads are also hanging from the top of the cabinet with a helmet in between; the insoles, elbow pads and helmet all hang in front of the pants.

The ambient heat in a home assists the drying activity. Using ambient heat rather than adding a heater, makes for a safe system. Air flow is improved when the cabinet is fairly well sealed such that the fan draws the air from the top and it flows right down. Since heat naturally rises, pulling the warmer higher in through the top of the cabinet to the bottom maximizes the benefit of the warm air. Warmer air is a relative term and the cabinet of the present invention works in air conditioned homes as well.

In an alternative of the present invention, air could be drawn from the bottom to the top if a fan is placed at the top of a cabinet, but this may result in longer dry times unless a warmer air is found at the bottom of the cabinet, for example through the location of a forced air vent. If an embodiment of the present invention includes a body 10 with a wide bench shape, the fan can be placed at one side and the air could enter from a vent at the other side. Again, the drying time will be reduced if warmer air is entering the cabinet.

FIGS. 1 to 2 show outside hooks 55 on the body of the cabinet 5. The outside hooks 55 or other suspending means are included if needed, for example, for such items as goalie pads, sports bags and other equipment that does not have much if any sweat on it such as hockey and lacrosse sticks, aids, snowboards, ski poles.

FIGS. 4 to 5 show another embodiment of a filter holder of the present invention. The filter holder 40 has a grate 110 upon which a filter 50 rests and a top filter vent 105 allows air to enter from above the filter rather than from the side. Although it is not required, a scented dryer sheet 115 can be laid over the filter 50, which gives a scent to the air exhausted from the cabinet 5. Likewise, an air freshener may be sprayed or suspended in the cabinet if desired.

FIG. 5 additionally shows how the top filter vent 105 may include a hinge 120 to flip it open for replacing a filter 50 and/or scented dryer sheet 115. Alternatively, the top filter vent 105 may be placed on top of the filter holder 40 and simply be lifted off when the filter 50 and/or scented dryer sheet 115 are replaced.

FIGS. 4 to 5 show arrows to indicate the direction of air flow when the fan is turned on. Air enters the top filter vent 105, passes through filter 50, then the scented dryer sheet 115, through the grate 110 and out the lower vent 35.

The cabinet 5 of the present invention can he made in a variety of dimensions. The following are examples of the potential sizes of cabinet 5 which are described as tall for a larger higher cabinet and short for a smaller shorter cabinet. A tall cabinet can be used to accommodate lots of equipment or larger equipment and a short cabinet can be used for smaller equipment or for less equipment. A tall cabinet could have the dimensions of 69 inch height, 20 inch depth and either 25 or 30 inch width.

The strength of a fan 100 can be varied depending on the size of the cabinet. For example, a tall cabinet could have a 70 CFM (“cubic feet per minute”) fan for the 25 inch wide cabinet and a 100 CFM fan for the 30 inch wide cabinet. Of course every fan could have fan with high CFM, but that would not be energy conserving or cost sensitive.

A wider cabinet of 30 inches can be used when the amount of equipment is greater or when the equipment itself is bigger, for example, for goalies. In an embodiment of a cabinet for goalie equipment, the goalie gloves can be held with heavier duty hanging hooks, and goalie pants can be held open with additional hooks. In order to improve air flow to goalie pants, the upper bar 60 can be shifted forward. Given the size and weight of goalie pads, a heavy duty bar with a mounting bracket can be attached to the outer side of the cabinet for hanging these heavy pads. A tall cabinet of 69×20×30 inch wide is helpful for a goalie but also for two youths with hockey equipment. For two youths there are duplicate hooks and clamps since there are two sets of everything.

Cabinets that are shorter are sufficient when less equipment is involved in a sport, or the equipment is for smaller people (e.g. children), or there is simply less space available as with apartments/condos. It is desirable to use the present invention to store and/or dry equipment that doesn't take up as much room, such as equipment used for activities like speed skating, figure skating, fitness, running, horse riding, cycling, and skateboarding. The smaller cabinet can still it an adult's hockey equipment too, although not providing as much space for air movement. A smaller cabinet can be of any size that its the equipment to store and/or dry, for example 35 inches high with a depth of 20 inches and a width of 25, 28 or 30 inches. The fan of such a smaller cabinet can be 50 CFM or 70 CFM, particularly for the 30 inch width cabinet.

In use, the present invention dries equipment quicker when the dampest or hardest to air equipment is placed near the bottom since that is the location of the fan. It is understood that if the fan were placed at the top of the cabinet and vents were placed at the bottom for air intake, that such hard to dry equipment would be moved near the fan. In an example using hockey equipment as shown in FIGS. 1 to 3, skates and gloves are mounted above the fan; shin guards can be hung higher up; and elbow pads and insoles can hang from clips at the top of the cabinet.

An active charcoal filter is used in order to trap and kill bacteria and the exhaust air released from the cabinet is clean moist air without odour. An active charcoal filter may be replaced annually and can be of the size 7.5 inches by 8.5 inches which is a standard size that is available. It is understood that if other filters are presently available or developed which provide the characteristics of killing bacteria and trapping odour that they could also be used with the present invention, as well as charcoal filters of other dimensions. A scented dryer sheet is optional but is not required.

The fan used in the present invention can be any fan with an air displacement system that is preferably compact, has a high rate of airflow and is quiet. A bath ventilation fan has all of these qualities and is also designed to work in a moist environment, exchange the air, and remove any foul odours in a reasonable amount of time, and is compact and relatively quiet.

The present invention describes a drying cabinet with the preferred features of a fan at the bottom to draw naturally warmer air from an intake at the top and avoid the safety issue of a heater; a ventilation fan of 50-100 CFM; air exhaust at the bottom through the front of the cabinet so that the cabinet can be placed in any corner and still be capable of exhausting the air; and a charcoal filter for capturing odours.

The cabinet of the present invention is filled with suspending means for hanging and holding articles for storing and/or drying and in an embodiment designed for drying and storing hockey equipment the suspending means are placed such that the skates and gloves are at the bottom closest to the fan and there is a moulded assembly above that for hanging and opening up the shoulder pads. Given that the rest of the equipment is either smaller or not as wet, it can be hung higher, for example, the shin pads can hang on either side of the shoulder pads; and the pants, helmet, elbow pads and insoles can be hung at the top under the air intake vent.

Although sports equipment is an especially large problem for which the present invention provides a solution, the present solution is also useful for drying any similar articles and articles of clothing, for example, after the washing machine. As well, the cabinet of the present invention is useful for hanging clothes after work, particularly for workers in industries in which strong odours are emitted at the job site, or in which sweating occurs. The cabinet can store, dry and contain odour from work pants, shirts and coveralls, and freshen those clothes for the next day's work.

The suspending means may be the bars, hangers, hooks and clamps described herein and any other means for holding or hanging an article in the cabinet for airing, such as wire mesh shelves or hanging lines with clothespins etc.

While embodiments of the invention have been described in the detailed description, the scope of the claims should not be limited by the preferred embodiments set forth in the examples, but should be given the broadest interpretation consistent with the description as a whole.

What is claimed is:

1. A cabinet having an inner cavity extending from the top of the cabinet to the bottom of the cabinet, said cabinet comprising:
at least one door;
an air intake vent at the top;
an air exhaust vent at the bottom;
an air circulation fan at the bottom in the inner cavity, said fan capable of being turned on and off; and
one or more suspending means in the inner cavity for suspending one or more articles.

2. The cabinet of claim 1 wherein the fan is electric and turned on and off with a switch on the outside of the cabinet.

3. The cabinet of claim 1, in which the fan is electric and the fan is turned on and off with a timer.

4. The cabinet of claim 1, in which the suspending means are selected from the group comprising: bars, hooks, clamps and hangers.

5. The cabinet of claim 1, in which the articles are sports equipment.

6. The cabinet of claim 1, in which the articles are clothing.

7. The cabinet of claim 1, in which the suspending means closest to the fan are capable of suspending the articles that require the most time to dry when said articles contain moisture.

8. The cabinet of claim 1, in which the suspending means comprise at least a first horizontal bar adjacent the bottom with hooks for suspending hockey skates and hockey gloves, and above said first bar, a second horizontal bar moulded for suspending shoulder pads.

9. A cabinet with at least one door and with a fan in the bottom of the cabinet, wherein when said fan is on and the doors are closed, air enters through an intake vent located near or at the top of the cabinet and exits out an exhaust vent located near or at the bottom of the cabinet.

10. A method of drying one or more articles comprising the steps of:
suspending one or more articles in a cabinet having suspending means for suspending the articles, said cabinet also comprising at least one door, an air circulation fan and an exhaust vent at the bottom, and an intake vent at the top;
closing the doors; and
turning on the fan.
